(19) United States
(12) Patent Application Publication
(10) Pub. No.: US 2022/0408975 A1
(43) Pub. Date: Dec. 29, 2022

(54) FOOD PROCESSOR AND POUR SPOUT

(71) Applicant: Black & Decker, Inc., New Britain, CT (US)

(72) Inventors: Evan Eskridge, Baltimore, MD (US); Daniel Langford, Baltimore, MD (US); Tyler Martin Knight, Ellicott City, MD (US); Ashok Baskar, Glen Arm, MD (US); Waverly Shivers, Jr., Halethorpe, MD (US)

(21) Appl. No.: 17/939,673

(22) Filed: Sep. 7, 2022

Related U.S. Application Data
(63) Continuation-in-part of application No. 17/167,150, filed on Feb. 4, 2021.

(51) Int. Cl. A47J 43/07; A47J 43/044

(52) U.S. Cl. CPC A47J 43/0705; A47J 43/044; A47J 2043/04454

(57) ABSTRACT

The present invention is directed to a food processor having a lid with a pour spout. The spout includes a wide mouth opening for easy introduction of food and liquids, and has a body that protrudes into the interior of the processor container. The spout body narrows as it extends into the interior of the container and is angled so that it points toward the center of the container. This helps to prevent splashback of food as its chopped while the food processor is operating.

### CROSS-REFERENCE TO RELATED APPLICATION

This application is a continuation-in-part of U.S. Ser. No. 17/167,150, filed Feb. 4, 2021, the disclosure of which are incorporated herein by reference in their entirety.

### FIELD OF THE INVENTION

This application is directed to a food processor, and in particular, a pour spout for a food processor that allows liquids and solid food to be introduced into the processor while preventing liquid from splashing out while the processor is operating.

### BACKGROUND OF THE INVENTION

This section provides background information related to the present disclosure which is not necessarily prior art.

Food processors are kitchen appliances used to help in meal preparation and typically include a bowl or container and a spinning blade to quickly blend, chop and/or dice food materials in the bowl. It is often desirable to add additional foods or liquids to the food processor while it's operating, and so the bowls often contain a spout for adding the additional food or liquid. However, existing spout designs provide the opportunity for food or liquid to be ejected out of the bowl and cause a mess.

### BRIEF SUMMARY OF THE INVENTION

Therefore, the present invention provides a food processor having an improved spout design. Furthermore, the present food processor can come as a stand-alone device or as an attachment to a powerhead like the one described in the parent application Ser. No. 17/167,150, which is hereby incorporated by reference.

In accordance with one aspect of the invention, a food processor includes a container for holding food, a blade assembly within the container for cutting the food and a lid that's removably secured to a top of the container. The lid includes a spout having a body protruding into the container and the body having a central axis that is angled so to the central axis of the container.

In another aspect of the invention, the spout has an exterior opening and an interior opening, the exterior opening being larger than the interior opening so that the spout body narrows as it moves towards the interior of the container.

In yet another aspect of the invention, the food processor includes a blade assembly with at least two blades at different heights.

Further areas of applicability will become apparent from the description provided herein. The description and specific examples in this application are intended for purposes of illustration only and are not intended to limit the scope of the present disclosure.

### BRIEF DESCRIPTION OF THE INVENTION

Further features and advantages of the present invention will be better understood by reference to the following description, which is given by way of example and in association with the accompanying drawings, in which:

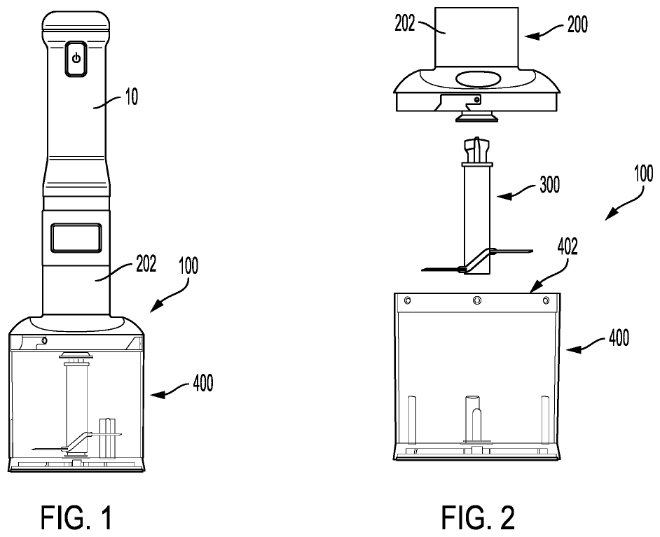

FIG. 1 shows a powerhead and a food processor of the present invention;

FIG. 2 shows the food processor of FIG. 1;

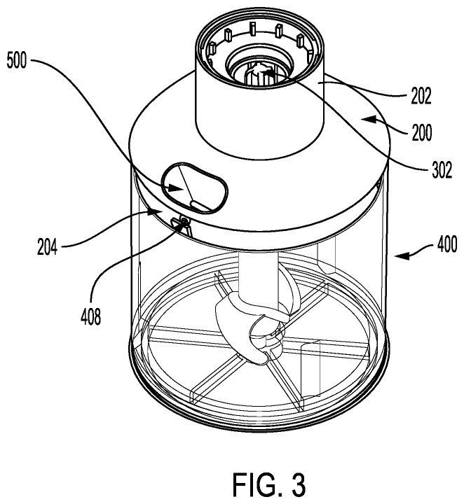

FIG. 3 is a top perspective view of the food processor;

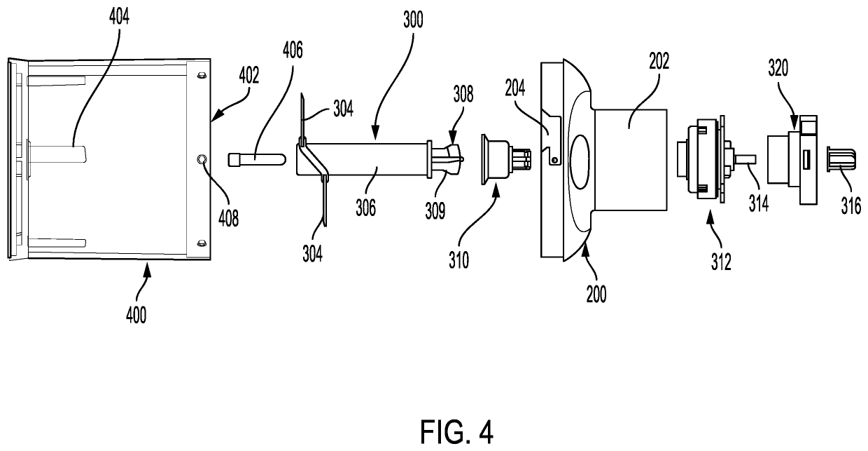

FIG. 4 is an exploded view of the food processor; and

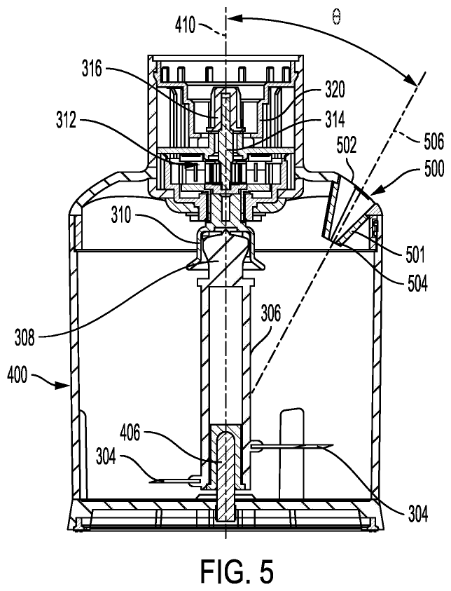

FIG. 5 is a side sectional view of the food processor.

### DETAILED DESCRIPTION OF THE INVENTION

FIG. 1 shows a food processor 100 of the present invention attached to a powerhead head unit 10. The powerhead unit 10 include a motor, a power source (such as a battery) and other components necessary to operate the food processor. A description of an exemplary powerhead 10 is provided in Ser. No. 17/167,150, from which this application claims priority. The food processor 100 is connected to a motor in the powerhead through a coupling, as will be described later.

Referring now to FIG. 2, the food processor 100 is shown generally in three parts, the lid 200, the blade assembly 300 and the container 400. FIG. 3 shows the assembled food processer where the lid 200 sealingly covers an opening 402 in the top of the container 400 and holds the blade assembly 300 therein. The lid 200 has a neck 202 which engages with the powerhead 10 to provide a tight seal to prevent ingress into the interior of the powerhead or lid.

FIG. 4 shows an exploded view of the food processor 100. The bottom of the container 400 (shown in the figure to the left) includes a rod 404 for holding a pin insert 406. The pin insert 406 is press fit onto the rod 404, but can be secured in any known manner, such as for example adhesives or fasteners. A housing 306 of the blade assembly 300 includes an opening allowing it to be slid over the pin insert 406. The pin insert 406 supports the blade assembly 300, allowing it to spin.

FIGS. 4 and 5 show the blade assembly 300 having two blades 304 placed on opposing sides of the housing 306. The blades 304 are positioned generally at a lower end of the housing 306 at uneven heights which provides for a more efficient chopping or cutting action. Although only two blades are shown, any number of blades can be used at varying or identical heights to increase chopping efficiency.

The top of the blade housing 306 includes a blade coupling 308 that is removably secured within a transmission coupling 310. The transmission coupling 310 is generally bell-shaped and fits over the blade coupling 308 when the lid 200 is placed over the container. The transmission coupling 310 is secured to a transmission 312 which includes a drive shaft 314. The transmission 312 is secured by the interior walls of the neck portion 202 and a rib attachment 320 prevents movement in the axial direction.

The drive shaft 314 is fixed to the power coupling 316, which mates with a drive shaft of a motor contained in the powerhead 10.

The lid 200 is removable so that the interior of the container 400 can be accessed. The lid includes a bayonet type slot 204 that secures a pin 408 on the container so that the lid can be twisted into a locked position. Since the lid 200 is removable, the transmission coupling 310 needs to be releasably connectable to the blade coupling 308. The blade coupling is generally “+” shaped with four fins 309 that are secured within the transmission coupling 310, and when connected, rotational motion is transferred from the transmission 312 to the blade assembly 300. It should be understood that any shape that rotationally fixes the transmission coupling 310 to the blade coupling 308 can be used, and the shape shown in the figure is just an example.

Now, in reference to FIGS. 3 and 5, a spout 500 is shown formed in the lid 200. The spout 500 has body 501 having an oval shaped exterior opening 502 that narrows as it travels inwardly into the container 400 to a smaller interior opening 504. The spout has a central axis 506 that is angled towards the center of the container 400.

The radial dimension of the exterior opening 502 is formed to be as large as possible and as far from the central axis 410 of the container as possible within the parameters allowed by the lid. Moving the spout away from the container central axis 410 allows the angle 508 to be larger. In this way, when liquids or other materials are introduced into the container, they are directed toward the center of the vertex created when the food processor is running and ensures contact with the cutting blades 304 before they are propelled outwardly toward the container wall. Additionally, angling the spout axis 506 reduces the chances that any deflected liquid or material rebound back out through the spout 500. In a preferred embodiment, the angle is between 10-45 degrees, and in a still preferred embodiment, the angle is between 20-35 degrees. However, the dimension of the exterior opening 502 are limited due to optimizing the flow rate into the smaller opening 504, and the internal geometry of the spout must not interfere with the geometry created for the transmission housing.

One of the benefits of having a larger exterior opening 502 is that it allows for easier pouring by a user and reduces spillage, while the smaller interior opening 504 prevents a user's fingers from protruding through. In a preferred embodiment the interior opening is no larger then 3 mm.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure

1. A food processor, comprising:
a container for holding food, the container having a central axis;
a blade assembly within the container for cutting the food;
a lid that's removably secured to a top of the container, and wherein the lid includes a spout for introducing food into the container, the spout having a body protruding into the container and the body having a central axis, the spout central axis being angled so that it intersects the central axis of the container within the boundaries of the container.

2. The food processor according to claim 1, wherein the angle between the central axis of the spout and the central axis of the container is between 20-35 degrees.

3. The food processor according to claim 1, wherein the spout has an exterior opening and an interior opening, the exterior opening being larger than the interior opening so that the spout body narrows as it moves towards the interior of the container.

4. The food processor according to claim 3, wherein the blade assembly includes at least two blades at different heights.

5. A powered food processor, comprising:
a powerhead having a motor;
a food processor having a container for holding food, the container having a central axis, a blade assembly within the container for cutting the food, and a lid that's removably secured to a top of the container;
wherein the lid includes a spout for introducing food into the container, the spout having a body protruding into the container and the body having a central axis, the spout central axis being angled so that it intersects the central axis of the container within the boundaries of the container;
wherein the container includes a neck portion that can be detachably coupled to the powerhead; and
wherein when the food process is attached to the powerhead, the motor drives the blade assembly in a spinning motion.

6. The food processor according to claim 5, wherein the angle between the central axis of the spout and the central axis of the container is between 20-35 degrees.

7. The food processor according to claim 5, wherein the spout has an exterior opening and an interior opening, the exterior opening being larger than the interior opening so that the spout body narrows as it moves towards the interior of the container.

8. The food processor according to claim 7, wherein the blade assembly includes at least two blades at different heights.

9. Method claims: To be added.
